(19) United States
(12) Patent Application Publication
(10) Pub. No.: US 2006/0164346 A1
(43) Pub. Date: Jul. 27, 2006

(54) Emissive-reflective display and a method for adjusting the display mode thereof

(76) Inventors: Chi-Chang Liao, Tai Nan City (TW); Hsing-Lung Wang, Ping Jen City (TW); Jau-Min Ding, Taipei City (TW); Chih-Chiang Lu, Hsin Chu City (TW); Shie-Chang Jeng, Ping Tung Hsien (TW)

Correspondence Address: RABIN & BERDO, P.C., Suite 500, 1101 14th Street, N.W., Washington, DC, 20005, US

(21) Appl. No.: 11/266,315

(22) Filed: Nov. 4, 2005

(30) Foreign Application Priority Data
Jan. 25, 2005 (TW) 94102150

(51) Int. Cl. G09G 3/30

(52) U.S. Cl. 345/76

(57) ABSTRACT

An emissive-reflective display and a method for determining the display mode thereof are provided. The emissive-reflective display is composed of emissive components and reflective components. The emissive component and the reflective components exist in a pixel. The emissive-reflective display has good image quality whether it is operated either indoors or outdoors. The present invention also provides a method that a user can judge and select a preferred display mode according to the environment and user's satisfaction.

### BACKGROUND OF THE INVENTION

1. Field of the Invention

The present invention relates to an emissive-reflective display and a method for adjusting the display mode thereof. In particular, this invention provides an emissive-reflective display that is made by emissive components and reflective components and a method for adjusting the display mode thereof.

2. Description of the Related Art

Liquid crystal displays have recently become the most popular display units. They have already replaced cathode radial tube displays and are becoming a necessary peripheral for personal computers or other electrical products. A liquid crystal display is a non-emissive display. According to the application, a liquid crystal display can be divided into a transmissive display, a reflective display and a transflective display. An OLED and a PLED are emissive displays.

The above displays have different advantages. A transmissive display has a good image quality when the environment is dark. A reflective display utilizes the external light source to achieve the display effect. Therefore, it has a better display effect and a better contrast in outdoor environments or when there is a strong light source. It can reduce the power consumption due to no back light unit. A transflective display has the advantages of the transmissive display and the reflective display. It achieves the display effect by utilizing the back light source and the environmental light source. An emissive display has the advantages of high image quality and high contrast. It also consumes less power than a traditional transmissive display.

Many patents that are related to a display by utilizing emissive components are disclosed. They can be divided into transmissive displays, reflective displays and transflective displays with emissive backlight units.

U.S. patent publication number 20040109106 “Liquid Crystal Display Device” discloses a transmissive display. It uses the emissive components, such as an OLED, as a backlight source. The liquid crystal display device substantially reduces the light loss between the gaps. Because the emissive components embed different polymers emitting various colors, such as red, green and blue, it can be a transmissive color display. The transmissive color display could replace the color filter layers and increases the light utilizing efficiency.

U.S. patent publication number 20040008178 “Transmissive Liquid Crystal Display Unit” discloses a transmissive liquid crystal display unit that uses organic emissive components as a back light source. The transmissive liquid crystal display unit comprises a liquid crystal panel, color filter components and an organic emissive component. A plurality of sub-pixels is disposed on the liquid crystal panel. The color filter components have different colors in order to display a color image and each color filter component is disposed on each sub-pixel. The organic emissive component is located behind the liquid crystal panel to act as a back light source.

U.S. patent publication number 20030063231 “LCD Panel Integrated with OLED” discloses a LCD panel that is integrated with OLED pixels to act as a light source. Each OLED pixel is comprised of different colors, including red, green and blue, and corresponds to each pixel of the panel. Each OLED pixel is an independent emissive light source.

U.S. Pat. No. 6,781,647 “Liquid Crystal Display Device Having A Front Light Unit” discloses a liquid crystal display device having a front light unit. The liquid crystal display device has a front light unit and is relatively cheap to produce. The liquid crystal display device comprises efficient and bright liquid crystal display components.

U.S. patent publication number 20030206256 “Display Device with Backlight” discloses a transflective display. The transflective display emissive components, such as LED or PLED, as a back light unit. It is relatively bright when operates in the condition of low voltage and low amount of power and reduces the display's size and cost.

U.S. patent publication number 20040164292 “Transflective Display Having an OLED Backlight” discloses a transflective display that uses an OLED as a back light unit. When the transflective display operates in both reflective mode and transmissive mode, the OLED will emit light.

The above-disclosed patents all have their own advantages. The emissive display has better image quality and high contrast in a dark environment. It also consumes a low amount of power compared to transitional transmissive displays that require a back light unit. However, it has the disadvantage of the contrast being affected when used in outdoors where there is a strong environmental light source, such as the sun. In contrast, a reflective display has the advantage of being easily and clearly seen when used in outdoors and consumes a low amount of power. Therefore, a display that consumes a low amount of power that is suitable for use in both the indoors and the outdoors can be obtained by combining the above advantages of the two kinds of displays discussed above.

Recently, U.S. Pat. No. 6,912,021 “Electro-Optical Device, Method For Driving Electro-Optical Device, Electronic Apparatus, And Method For Driving Electronic Apparatus” and US 2003/0201960 “Display Device And Driving Method Thereof have disclosed a display composed of a reflective LCD and an emissive display in a pixel. The reflective and emissive components are arranged in a layer-by-layer structure. Although such display has both of the good features of reflective and emissive displays, it suffers some manufacture problems, and the layer structure limits the flexibility of operation mode in the reflective part. For example, the high temperature manufacture process, such as PI baking, in the reflective LCD could damage the emissive component, and the required polarizer and quarter wave plate to prevent from the ambient light effect on the emissive display limits the operation mode of the reflective display part.

### SUMMARY OF THE INVENTION

The main purpose of the present invention is to provide an emissive-reflective display that is made by emissive components and reflective component in a pixel arranged side-by-side. The emissive-reflective display has good image quality whether it is operated either indoors or outdoors.

In order to achieve the above goal, the present invention provides an emissive-reflective display. The emissive-reflective display comprises an upper substrate, a lower substrate, at least one emissive component in a pixel disposed at the lower substrate and at least one reflective component in a pixel disposed at the lower substrate. The emissive components and reflective component in a pixel are arranged side-by-side.

The present invention also provides a method for adjusting the display mode of the emissive-reflective display. A user can adjust the display mode of the emissive-reflective display either in the emissive mode or in the reflective mode to reduce power consumption. If the user selects the emissive mode, and he is satisfied with the selected emissive mode, images are displayed using the emissive mode. If the user selects the reflective mode, and he is satisfied with the selected reflective mode, images are displayed using the reflective mode.

For further understanding of the invention, reference is made to the following detailed description illustrating the embodiments and examples of the invention. The description is used only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of an embodiment of the emissive-reflective display of the present invention; and

FIG. 2 is a flow chart of the method for adjusting the display mode of the emissive-reflective display of the present invention.

### DETAILED DESCRIPTION OF THE PREFERRED EMBODIMENTS

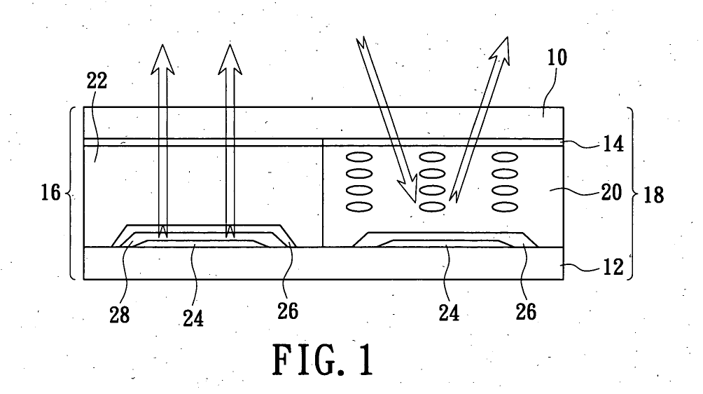

Please refer to FIG. 1, which shows a schematic diagram of an embodiment of the emissive-reflective display of the present invention. The present invention comprises an upper substrate 10 and a lower substrate 12. There are an emissive region and a reflective region between substrates. The upper substrate 10 and the lower substrate 12 are formed of either glass or plastic substrates. An upper electrode layer 14 is formed on the upper substrate 10. At least one emissive component 16 is disposed at the lower substrate 12. The emissive component 16 could be an OLED or a PLED. At least one reflective component 18 is disposed at the lower substrate 12.

A transparent layer 22 is formed between the upper electrode layer 14 and the lower substrate 12. A driving component 24 is formed on the lower substrate 12. An emissive component 28 is formed on the driving component 24. A separated layer 26 is formed on the emissive component 28. A reflective medium layer 20 is formed between the upper electrode layer 14 and the lower substrate 12. A driving component 24 that is formed on the lower substrate 12 and a separated layer 26 is formed on the emissive component 28.

In this embodiment, the driving component 24 is an electrode when the driving component 24 is a passive type; the driving component 24 is a thin film transistor when the driving component 24 is an active type. The emissive component 28 is a material that can emit light. The separated layer 26 is a deactivation layer or an alignment layer. The reflective medium layer 20 could be composed of reflective type media such as liquid crystal and electrophoretic particles. The emissive components 16 and the reflective components 18 are disposed between the upper substrate 10 and the lower substrate 12 and are disposed in a pixel side by side. The emissive components in a sub-pixel 16 and the reflective components in a sub-pixel 18 can be driven either in active types or in passive types.

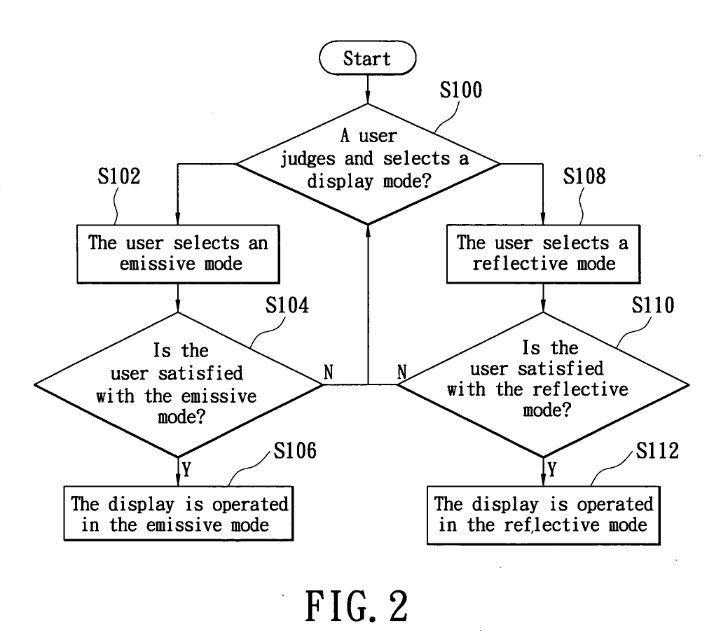

Please refer to FIG. 2, which shows a flow chart of the method for adjusting the display mode of the emissive-reflective display of the present invention. A user can adjust the display mode of the emissive-reflective display to reduce power consumption. A user judges and selects a display mode (S100) in the beginning. If the user selects the emissive mode (S102), then he determines whether he is satisfied with the emissive mode (S104). If the answer is yes, the display is operated in the emissive mode (S106). If the answer is no, he repeats the step of S100. If the user selects the reflective mode (S108), then he determines whether he is satisfied with the reflective mode (S110). If the answer is yes, the display is operated in the reflective mode (S112). If the answer is no, he goes back to the step of S100.

The present invention provides an emissive-reflective display that is composed of emissive components and reflective components. The emissive component and the reflective components exist in a pixel. The emissive-reflective display has good image quality whether it is operated indoors or outdoors. The disposed method can be a side-by-side way or an up-down stacked way. The present invention also provides a method that a user can judge and select the display mode according to the environment and user's satisfaction.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An emissive-reflective display, comprising:
an upper substrate and a lower substrate, wherein there are an emissive region and a reflective region between substrates;
at least one emissive component in a pixel, disposed in the emissive region; and
at least one reflective component in a pixel, disposed in the reflective region;
wherein the emissive component and reflective component are arranged side-by-side.

2. The emissive-reflective display of claim 1, further comprising:
an upper electrode layer, formed on the upper substrate;
a transparent layer, formed between the upper electrode layer and the lower substrate; and
a reflective medium layer, formed between the upper electrode layer and the lower substrate.

3. The emissive-reflective display of claim 2, wherein the transparent layer comprises:
a driving component, formed on the lower substrate;
an emissive component, formed on the driving component; and
a separated layer, formed on the emissive component.

4. The emissive-reflective display of claim 3, wherein the driving component is an electrode when the driving component is a passive type,

5. The emissive-reflective display of claim 3, wherein the driving component is a thin film transistor when the driving component is an active type.

6. The emissive-reflective display of claim 3, wherein the separated layer is a deactivation layer.

7. The emissive-reflective display of claim 2, wherein the reflective medium layer includes liquid crystal or electrophoretic particles.

8. The emissive-reflective display of claim 2, wherein the reflective medium layer comprises:
a driving component, formed on the lower substrate; and
a separated layer, formed on the driving component.

9. The emissive-reflective display of claim 8, wherein the driving component is an electrode when the driving component is a passive type.

10. The emissive-reflective display of claim 8, wherein the driving component is a thin film transistor when the driving component is an active type.

11. The emissive-reflective display of claim 8, wherein the separated layer is a deactivation layer or an alignment layer.

12. The emissive-reflective display of claim 1, wherein the emissive components and the reflective components in the pixel are an active type.

13. The emissive-reflective display of claim 1, wherein the emissive components and the reflective components in the pixel are a passive type.

14. A method for determining the operation mode of the emissive- reflective display to achieve the goal of reducing power consumption, the method comprises:
judging and selecting a display mode in the beginning;
if the user selects the emissive mode, he determines whether he is satisfied with the selected emissive mode;
displaying the images using the self-emissive mode;
if the user selects a reflective mode, he determines whether he is satisfied with the selected reflective mode; and
displaying the images using the reflective mode.

15. The method for determining the display mode of the emissive- reflective display of claim 14, wherein the step of judging whether the user is satisfied with the selected emissive mode further comprises:
if the user is satisfied, displaying the images using the emissive mode; and
if the user is unsatisfied, goes back to the step of judging and selecting a display mode by a user.

16. The method for determining the display mode of the emissive- reflective display of claim 14, wherein the step of judging whether the user is satisfied with the selected reflective mode further comprises:
if the user is satisfied, displaying the images using the reflective mode; and
if the user is unsatisfied, goes back to the step of judging and selecting a display mode by a user.
